(19) United States
(12) Patent Application Publication
(10) Pub. No.: US 2020/0177588 A1
(43) Pub. Date: Jun. 4, 2020

(54) USER EQUIPMENT (UE) BLACKLIST OVERRIDE FOR CELLULAR NETWORK

(71) Applicant: GM GLOBAL TECHNOLOGY OPERATIONS LLC, Detroit, MI (US)

(72) Inventors: Bonnie CHEN, Colleyville, TX (US); Scott T. DROSTE, West Bloomfield, MI (US)

(21) Appl. No.: 16/203,844

(22) Filed: Nov. 29, 2018

(51) Int. Cl. H04L 29/06; H04W 8/24

(52) U.S. Cl. CPC H04L 63/0876; H04W 8/24; H04L 63/101; H04L 63/0853

(57) ABSTRACT

A system and method of overriding a blacklist indicator for a user equipment (UE). The method includes obtaining a subscriber identifier of the UE; obtaining an equipment identifier from the UE; retrieving subscriber information from a subscriber server based on the subscriber identifier; determining whether the equipment identifier is blacklisted; when it is determined that the equipment identifier is blacklisted, determining whether the subscriber information includes a blacklist override indicator that indicates to override blacklisting of the equipment identifier; and when it is determined to override the blacklisting of the equipment identifier, providing cellular services to the UE.

### INTRODUCTION

The present invention relates to blacklisting of user equipment (UE) on a cellular network.

Cellular networks (or cellular carrier systems) provide cellular communications for a variety of cellular devices, referred to broadly herein as user equipment (UE). These cellular networks typically include databases that store information pertaining to UE subscription information, such as whether a particular device holds an active subscription for carrying out cellular communications. Certain UEs can have their subscription blacklisted and/or the UE device itself can be blacklisted. When blacklisted, the cellular network will not provide cellular communications services to the blacklisted UE.

### SUMMARY

According to one aspect of the invention, there is provided a method of overriding a blacklist indicator for a user equipment (UE), the method including: obtaining a subscriber identifier of the UE; obtaining an equipment identifier from the UE; retrieving subscriber information from a subscriber server based on the subscriber identifier; determining whether the equipment identifier is blacklisted; when it is determined that the equipment identifier is blacklisted, determining whether the subscriber information includes a blacklist override indicator that indicates to override blacklisting of the equipment identifier; and when it is determined to override the blacklisting of the equipment identifier, providing cellular services to the UE.

According to various embodiments, this method may further include any one of the following features or any technically-feasible combination of some or all of these features:
the subscriber identifier is an international mobile subscriber identity (IMSI);
the IMSI is stored at the UE in an embedded subscriber identity module (SIM);
the determining step includes obtaining a blacklist equipment override list based on the IMSI and determining whether the equipment identifier is included in the blacklist equipment override list, wherein the blacklist equipment override list is the blacklist override indicator;
the subscriber information includes a subscriber profile that is associated with the subscriber identifier;
the subscriber profile is retrieved from the subscriber server at a time separate than a time in which the blacklist override indicator is retrieved;
the blacklist override indicator is retrieved from the subscriber server in response to determining that the equipment identifier is blacklisted;
the blacklist override indicator is a blacklist override flag that is stored at the subscriber server;
the equipment identifier is an international mobile equipment identity (IMEI), and wherein the IMEI is received from the UE via cellular communications;
the blacklist indicator is received from an equipment identity register (EIR) based on the IMEI; and/or
the subscriber information, the IMEI, the blacklist indicator, and the blacklist override indicator are received at a mobility management entity (MME).

According to another aspect of the invention, there is provided a method of overriding a blacklist indicator for a user equipment (UE), the method including: obtaining an international mobile subscriber identity (IMSI) of a telematics unit of a vehicle, wherein the telematics unit is the UE and wherein the IMSI is stored in an embedded subscriber identity module (SIM) of the vehicle; receiving an international mobile equipment identity (IMEI) from the telematics unit, wherein the IMEI is stored in memory of the vehicle; determining whether the IMSI or IMEI is associated with a blacklist override indicator; and when it is determined that the IMSI or IMEI is associated with a blacklist override indicator, providing cellular services to the telematics unit regardless of whether the IMEI is blacklisted.

According to various embodiments, this method may further include any one of the following features or any technically-feasible combination of some or all of these features:
determining whether the IMEI is blacklisted by querying an equipment identity register (EIR) based on the IMEI;
the obtaining step and the receiving step are carried out as a part of a 3rd Generation Partnership Project (3GPP) cellular protocol;
when it is determined that the IMSI is associated with the blacklist override indicator, providing the cellular services to the telematics unit regardless of whether the IMEI is blacklisted and without making a determination as to whether the IMEI is blacklisted;
the obtaining step and the receiving step are carried out as a part of an attach procedure and in response to a cellular service request from the UE;
the method is carried out by a cellular network;
the method is carried out by a computer system at a cellular base station of the cellular network, wherein the computer system includes one or more electronic computers;
the method steps are carried out as a part of an attach procedure, and wherein the providing step includes carrying out remaining steps of the attach procedure; and/or
the blacklist override indicator is stored on the cellular network at a location other than a subscriber server of the cellular network.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a cellular network; and

FIG. 3 is a flowchart of an embodiment of a method of overriding a blacklist indicator for a user equipment (UE).

### DETAILED DESCRIPTION

The system and method described below permits cellular services for user equipment (UE) in certain instances regardless of whether an equipment identifier (e.g., an international mobile equipment identity (IMEI)) for the UE is blacklisted. The UE considered herein may be any cellular device, such as a phone, a telematics unit, an Internet of Things (IoT) device, to name but a few. In some scenarios, a UE may be blacklisted so that it will not be permitted to carry out cellular services—that is, the UE will be denied cellular services by the cellular network. For example, according to at least one scenario, when the UE is stolen, the cellular operator may blacklist the equipment identifier (e.g., the IMEI) of the UE, as well as the subscriber identifier (e.g., an international mobile subscriber identity (IMSI)). However, in some instances, a particular UE may erroneously be blacklisted, such as when a cellular operator mistakenly inputs the wrong IMEI due to a typographical error (e.g., fat-fingering the IMEI when entering it into the cellular network). Thus, the method and system below provide for enabling and providing cellular services in certain instances even though the IMEI is blacklisted and would otherwise be denied service by the cellular network.

Some UEs include equipment (or hardware) that contains an embedded subscriber identity module (SIM). As used herein, an “embedded SIM” is a SIM that is a fixed part of the UE and is not intended or configured to be removed from the UE. According to some embodiments, vehicles contain a telematics unit that provides cellular connectivity to the vehicle and, thus, operates as a UE. In at least some scenarios, the UE of the vehicle includes an embedded SIM. In at least one embodiment, the UE of the vehicle (e.g., the telematics unit of the vehicle) includes an IMEI and an IMSI that are inseparable from one another. These UEs can be associated with a blacklist override indicator (or flag) that is stored at the cellular network. Thus, when an IMEI of the UE is mistakenly blacklisted, for example, the UE is still permitted service when the blacklist override indicator is set to TRUE or otherwise indicates that the blacklisting of the IMEI should be overridden. Thus, cellular service can be permitted to UEs when the UE holds an active (and/or valid) subscription even when the IMEI is mistakenly blacklisted. And, in at least one embodiment, if the UE is stolen, the UE can be denied service since the IMSI would be disabled (or inactive). Also, since the IMEI is not separable from the IMSI (because the IMSI is stored in an embedded SIM), the SIM cannot be separated from the UE and then used as a part of another blacklisted UE to gain cellular service pursuant to an active subscription of the IMSI. Of course, when the UE is actually stolen and correctly blacklisted, the subscription associated with the IMSI can be inactivated so as to not permit cellular services regardless of whether there is an associated blacklist override indicator—in this sense, the blacklist override indicator overrides the IMEI blacklisting, but not an inactive subscription.

Moreover, in some embodiments, the subscription identifier (e.g., IMSI) can be associated with a blacklist override equipment list. The blacklist override equipment list can be stored in the subscriber server and can indicate one or more UEs (or IMEIs) that the blacklist override indicator (or function) should apply to. For example, when the cellular network retrieves subscription information from the subscriber server, the cellular network can inspect the blacklist override equipment list to determine whether it contains the IMEI received from the UE. When the blacklist override equipment list contains the IMEI of the UE, then the blacklisting of the UE (or the IMEI) can be overridden and provided cellular services. This embodiment can be applied to, for example, UEs that include a removeable SIM, such as a SIM card. Thus, even if the SIM card inserted into another (stolen or blacklisted) UE, the cellular service will not override the IMEI (or equipment identifier) blacklisting since the other UE (or IMEI thereof) is not on the blacklist override equipment list.

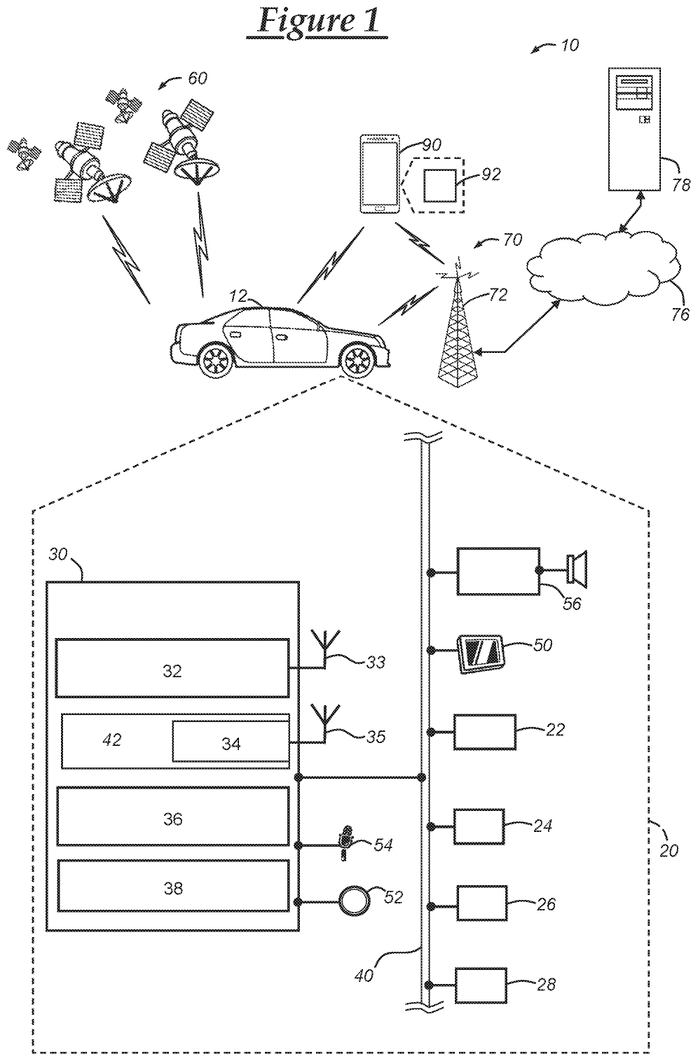

With reference to FIG. 1, there is shown an operating environment that comprises a communications system 10 and that can be used to implement the method disclosed herein. Communications system 10 generally includes a vehicle 12 with a wireless communications device 30 and other VSMs 22-56, a constellation of global navigation satellite system (GNSS) satellites 60, one or more cellular systems (or networks) 70, a land communications network 76, a computer or server 78, and a handheld wireless device (HWD) 90. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. Some of the vehicle electronics 20 are shown generally in FIG. 1 and includes a global navigation satellite system (GNSS) receiver 22, a body control module or unit (BCM) 24, an engine control module (ECM) 26, other vehicle system modules (VSMs) 28, the wireless communications device 30, and vehicle-user interfaces 50-56. Some or all of the different vehicle electronics may be connected for communication with each other via one or more communication busses, such as communications bus 40. The communications bus 40 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

The vehicle 12 can include numerous vehicle system modules (VSMs) as part of vehicle electronics 20, such as the GNSS receiver 22, the BCM 24, the ECM 26, the wireless communications device 30, and the vehicle-user interfaces 50-56, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 can be connected by communications bus 40 to the other VSMs, as well as to the wireless communications device 30, and can be programmed to run vehicle system and subsystem diagnostic tests. Moreover, each of the VSMs can include and/or be communicatively coupled to suitable hardware that enables intra-vehicle communications to be carried out over the communications bus 40; such hardware can include, for example, bus interface connectors and/or modems. One or more VSMs 28 may periodically or occasionally have their software or firmware updated and, in some embodiments, such vehicle updates may be over the air (OTA) updates that are received from a computer 78 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites 60. GNSS receiver 22 can be configured to comply with and/or operate according to particular regulations or laws of a given geopolitical region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 60. And, in another example, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22.

Body control module (BCM) 24 can be used to control various VSMs of the vehicle, as well as obtain information concerning the VSMs, including their present state or status, as well as sensor information. The BCM 24 is shown in the exemplary embodiment of FIG. 1 as being electrically coupled to the communication bus 40. In some embodiments, the BCM 24 may be integrated with or part of a center stack module (CSM) and/or integrated with wireless communications device 30. Or, the BCM may be a separate device that is connected to other VSMs via bus 40. The BCM 24 can include a processor and/or memory, which can be similar to processor 36 and memory 38 of wireless communications device 30, as discussed below. The BCM 24 may communicate with wireless device 30 and/or one or more vehicle system modules, such as the engine control module (ECM) 26, audio system 56, or other VSMs 28. Software stored in the memory and executable by the processor enables the BCM to direct one or more vehicle functions or operations including, for example, controlling central locking, air conditioning, power mirrors, controlling the vehicle primary mover (e.g., engine, primary propulsion system), and/or controlling various other vehicle modules.

Engine control module (ECM) 26 may control various aspects of engine operation such as fuel ignition and ignition timing. The ECM 26 is connected to the communications bus 40 and may receive operation instructions (or vehicle commands) from the BCM 24 or other vehicle system modules, such as the wireless communications device 30 or other VSMs 28. In one scenario, the ECM 26 may receive a command from the BCM to start the vehicle—i.e., initiate the vehicle ignition or other primary propulsion system (e.g., a battery powered motor). In at least some embodiments when the vehicle is a hybrid or electric vehicle, a primary propulsion control module can be used instead of (or in addition to) the ECM 26, and this primary propulsion control module can be used to obtain status information regarding the primary mover (including electrical motor(s) and battery information).

Wireless communications device 30 is capable of communicating data via short-range wireless communications (SRWC). In the illustrated embodiment, wireless communications device 30 includes an SRWC circuit 32, a telematics unit 42 (including a cellular chipset 34), a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), BCM 24, display 50, an infotainment module, a head unit, and/or a gateway module. In one embodiment, the wireless communications device 30 can be or can include an infotainment unit that is operable to control or carry out at least part of an in-vehicle entertainment system that can be controlled through one or more vehicle-user interfaces, such as via touch-screen display 50, button 52, and/or microphone 54.

In one embodiment, the wireless communications device 30 includes the telematics unit 42 (or telematics control unit) (as shown in FIG. 1) that is capable of carrying out cellular communications using one or more cellular networks (or carrier systems) 70. The telematics unit 42 is an example of user equipment (UE) and, in particular, vehicle user equipment, which is a UE that is installed as a part of the vehicle electronics. The telematics unit 42 can include the cellular chipset 34, software or firmware, processor, and memory. In one embodiment, the processor and/or memory of the telematics unit 42 can be shared with other VSMs or used for other functionality, such as for SRWC services which are carried out by the wireless communications device 30. For example, the telematics unit 42 can use the processor 36 and/or the memory 38 of the wireless communications device 30. Or, in other embodiments, a separate telematics unit can be included in the vehicle and communicatively coupled to the wireless communications device 30; this separate telematics unit can include the cellular chipset 34 as well as its own dedicated processor and memory (or these components can be shared with other VSMs). In one embodiment, the telematics unit can be integrated with the GNSS receiver 22 so that, for example, the GNSS receiver 22 and the wireless communications device 30 (or telematics unit 42) are directly connected to one another as opposed to being connected via communications bus 40.

In many embodiments, the telematics unit 42 includes a subscriber identity module (SIM). The SIM can be an integrated circuit that securely stores an international mobile subscriber identity (IMSI) (or other subscriber identifier) for the telematics unit 42. In one embodiment, the SIM is an “embedded SIM.” In other embodiments, the SIM of the telematics unit 42 can be a “removeable SIM,” which as used herein is a SIM (e.g., a SIM card) that is removable and insertable into the UE. For example, the removeable SIM can be a SIM card that is insertable and removeable from a SIM card slot of the telematics unit 42. The IMSI can be stored on or within the SIM, which is separate from the memory 38 of the wireless communications device 30. The telematics unit 42 can also store an international mobile equipment identity (IMEI), which is an identifier that uniquely identifies the telematics unit 42, the wireless communications module 30, and/or parts thereof. The IMEI of the telematics unit 42 can be stored in one or more memory devices of the vehicle electronics 20, such as memory 38 or separate memory of the wireless communications device 30 and/or the telematics unit 42.

In some embodiments, the wireless communications device 30 can be configured to communicate wirelessly according to one or more short-range wireless communications (SRWC) such as any of the Wi-Fi™, WiMAX™, Wi-Fi Direct™, IEEE 802.11p, other vehicle to vehicle (V2V) communication protocols, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit 32 may allow the device 30 to connect to another SRWC device, such as the handheld wireless device (HWD) 90 or other vehicles.

The telematics unit 42 and/or the wireless communications device 30 may enable vehicle 12 to be in communication with one or more remote networks (e.g., one or more networks at computers 78) via packet-switched data communication. This packet-switched data communication may be carried out through use of a non-vehicle wireless access point that is connected to a land network via a router or modem. When used for packet-switched data communication such as TCP/IP, the communications device 30 (and/or telematics unit 42) can be configured with a static IP address or can be set up to automatically receive an assigned IP address from another device on the network such as a router or from a network address server.

Packet-switched data communications may also be carried out via use of a cellular network that may be accessible by the device 30 via the telematics unit 42. The cellular chipset 34 can enable data to be communicated over the cellular network 70. In such an embodiment, radio transmissions may be used to establish a communications channel, such as a voice channel and/or a data channel, with cellular system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single telephone call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 (and/or telematics unit 42) or can be shared with other vehicle systems. The processor 36 executes various types of digitally-stored instructions, such as software or firmware programs stored in memory 38, which enable the device 30 to provide a wide variety of services. Memory 38 may be a non-transitory computer-readable medium, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), or magnetic or optical disc drives.

The wireless communications device 30 can provide communications between various VSMs of the vehicle 12 and one or more devices external to the vehicle 12, such as one or more networks or systems at computer 78. This enables various vehicle operations to be carried out by “extra-vehicle” devices (or non-vehicle devices), including the HWD 90. For example, the wireless communications device 30 can connect to the HWD 90 so that telephone calls can be carried out using the vehicle-user interfaces.

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. Vehicle-user interfaces 50-54 are also onboard vehicle sensors that can receive input from a user or other sensory information. The pushbutton(s) 52 allow manual user input into the communications device 30 to provide other data, response, and/or control input (e.g., a windshield wiper activation or control switch). Audio system 56 provides audio output to a vehicle occupant and can be a dedicated, stand-alone system or part of the primary vehicle audio system. According to a particular embodiment, audio system 56 is operatively coupled to both vehicle bus 40 and an entertainment bus (not shown) and can provide AM, FM and satellite radio, CD, DVD and other multimedia functionality. This functionality can be provided in conjunction with or independent of an infotainment module. Microphone 54 provides audio input to the wireless communications device 30 to enable the driver or other occupant to provide voice commands and/or carry out hands-free calling via the cellular network 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, or a projector that can project graphics for viewing by a vehicle occupant. Various other vehicle-user interfaces can also be utilized, as the interfaces of FIG. 1 are only an example of one particular implementation.

Land network 76 may be a conventional land-based telecommunications network that is connected to one or more landline telephones and connects cellular network 70 to computer 78. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

The computers 78 (only one shown) can be some of a number of computers accessible via a private or public network such as the Internet. And, the computers 78 can be used for one or more purposes, such as for providing information regarding UEs. In some embodiments, the computers 78 can be, for example: a service center computer where diagnostic information and other vehicle data can be uploaded from the vehicle; a client computer used by the vehicle owner or other subscriber for various purposes, such as accessing and/or receiving vehicle sensor data (or other data), as well as setting up and/or configuring subscriber preferences or controlling vehicle functions; a car sharing server which coordinates registrations from a plurality of users who request to use a vehicle as part of a car sharing service; or a third party repository to or from which vehicle sensor data or other information is provided, whether by communicating with the vehicle 12, computer 78, or both. A computer 78 can also be used for providing Internet connectivity such as DNS services or as a network address server that uses DHCP or other suitable protocol to assign an IP address to vehicle 12.

The handheld wireless device (HWD) 90 is another example of user equipment (UE). The HWD 90 is a mobile device and a SRWC device (i.e., a device capable of SRWC) and may include: hardware, software, and/or firmware enabling cellular telecommunications and SRWC as well as other mobile device applications, such as a vehicle management application 92. The hardware of the HWD 90 may comprise: a processor and memory for storing the software, firmware, etc. The processor and memory of the HWD 90 can be any of those types as discussed with respect to processor 36 and memory 38 of the wireless communications device 30. The HWD 90 includes a SIM and, in many embodiments, can include a removeable SIM, such as a removeable SIM card that is insertable into a SIM card slot of the HWD 90. The HWD processor and memory may enable various software applications, which may be preinstalled or installed by the user (or manufacturer) (e.g., having a software application or graphical user interface (GUI)). In one embodiment, the application 92 enables a vehicle user to communicate with the vehicle 12 and/or control various aspects or functions of the vehicle, some of which are listed above. Additionally, one or more applications may allow the user to connect with the computer 78 or call center advisors at any time.

In one particular embodiment, the HWD 90 can be a personal cellular SRWC device that includes a cellular chipset and/or cellular connectivity capabilities, as well as SRWC capabilities. Using a cellular chipset, for example, the HWD can connect with various remote devices, including computers 78 via cellular network 70. As used herein, a personal SRWC device is a mobile device that is capable of SRWC, that is portable by a user, and where the portability of the device is at least partly dependent on the user, such as a wearable device (e.g., a smartwatch), an implantable device, or a handheld device (e.g., a smartphone, a tablet, a laptop). As used herein, a short-range wireless communications (SRWC) device is a device capable of SRWC. In some embodiments, the HWD 90 is a personal SRWC device.

The HWD 90 can also include a short range wireless communications (SRWC) circuit and/or chipset as well as one or more antennas, which allows it to carry out SRWC, such as any of the IEEE 802.11 protocols, Wi-Fi™, WiMAX™, ZigBee™, Wi-Fi Direct™ Bluetooth™, or near field communication (NFC). The SRWC circuit and/or chipset may allow the HWD 90 to connect to another SRWC device. Additionally, as mentioned above, the HWD 90 can include a cellular chipset thereby allowing the device to communicate via one or more cellular protocols, such as GSM/GPRS technology, CDMA or CDMA2000 technology, and LTE technology. The HWD 90 may communicate data over cellular network 70 using the cellular chipset and an antenna. In one embodiment, the HWD 90 can be an HWD of a vehicle user and can include a vehicle management application 92, as depicted in the illustrated embodiment of FIG. 1.

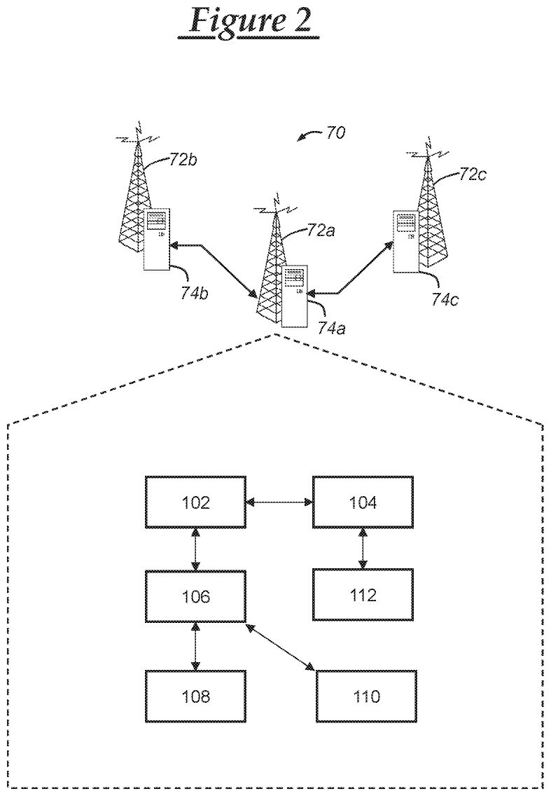

With reference to FIG. 2, there is shown a more detailed schematic of one potential cellular network (or cellular carrier system) 70, which is depicted as including three cell towers 72a-c and electronic processing systems 74a-c. Cellular network 70 may be any suitable wireless cellular system or network and the cellular network 70 can include any one or more of the following components (e.g., depending on the cellular technology): cellular towers, base transceiver stations, mobile switching centers, base station controllers, evolved node Bs, etc., as well as any other networking components required to connect cellular network 70 with the land network 76 or to connect the cellular network with user equipment (UEs, e.g., which can include telematics equipment in vehicle 12). Cellular network 70 can implement any suitable communications technology, including GSM/GPRS technology, CDMA or CDMA2000 technology, LTE technology, etc. In general, cellular networks 70, their components, the arrangement of their components, the interaction between the components, etc. is generally known in the art.

In one embodiment, the cellular system 70 is a cellular network that operates according to a 3rd Generation Partnership Project (3GPP) specification, such as the 3GPP 24.301 for 4G LTE circuit-switched and/or packet data services. Additionally or alternatively, the cellular network 70 can operate to provide 3G circuit-switched services and/or 3G packet data services according to the technical specification of 3GPP 24.008, and/or 5G New Radio packet data services according to the technical specification of 3GPP 25.301. Related network procedures for 3G operation, 4G LTE operation, and/or 5G operation can be found in the technical specifications of 3GPP 23.060, 23.401, and/or 23.501, as will be appreciated by those skilled in the art.

As an example, the cell tower 72a and accompanying computer system 74a is depicted as including an evolved node B (eNodeB) 102, a serving gateway (S-GW) 104, a mobility management entity (MME) 106, a home subscriber server (HSS) (or home location register (HLR)) 108, an equipment identity register (EIR) 110, and a provider gateway (P-GW) 112. The HSS 108 can be either an HSS or an HLR and, as used herein, subscriber server refers to either or both of an HSS or HLR. It should be appreciated that the cellular network 70 can, and in many embodiments does, include other components that are not depicted in the Figures or expressly described herein. The cellular network 70 provides cellular services to various devices or user equipment (UEs), such as the HWD 90 and the telematics unit 42 of the vehicle 12.

The UEs can initiate a request for service from a serving cellular network (or base station) by performing an attach procedure or process. This process can be carried out based on the type of cellular service (e.g., 3G, 4G LTE, 5G), and may be referred to by different names in the art, such as a “Location Update” procedure, a “GPRS Attach” procedure, an “Attach” procedure, a “combined Attach” procedure, etc. However, as used herein, “attach procedure” refers to any and/or all of these attach or registration procedures that are used with cellular networks. As a part of the attach procedure, the serving cellular network (e.g., as represented by cell tower 72a and computer system 74a) obtains a subscription identifier associated with the UE that is requesting cellular service. The subscription identifier is an identifier that uniquely identifies a subscription account that is held by a user. As an example, the subscription identifier can be an International Mobile Station Identifier (IMSI), which can be stored within the User Subscription Identity Module (or SIM) that is either embedded or inserted within the wireless device. Once the cellular network receives the IMSI (or other subscription identifier) from the UE (or other cellular network component (e.g., an old MME/SGSN)), the cellular network can retrieve a subscription profile (e.g., subscription information) from the home subscriber server (HSS) 108. Also, the cellular network can obtain an equipment identifier of the UE from the UE. The equipment identifier is an identifier that uniquely identifies the UE and can be, for example, an International Mobile Equipment Identifier (IMEI) that is globally unique to the wireless device.

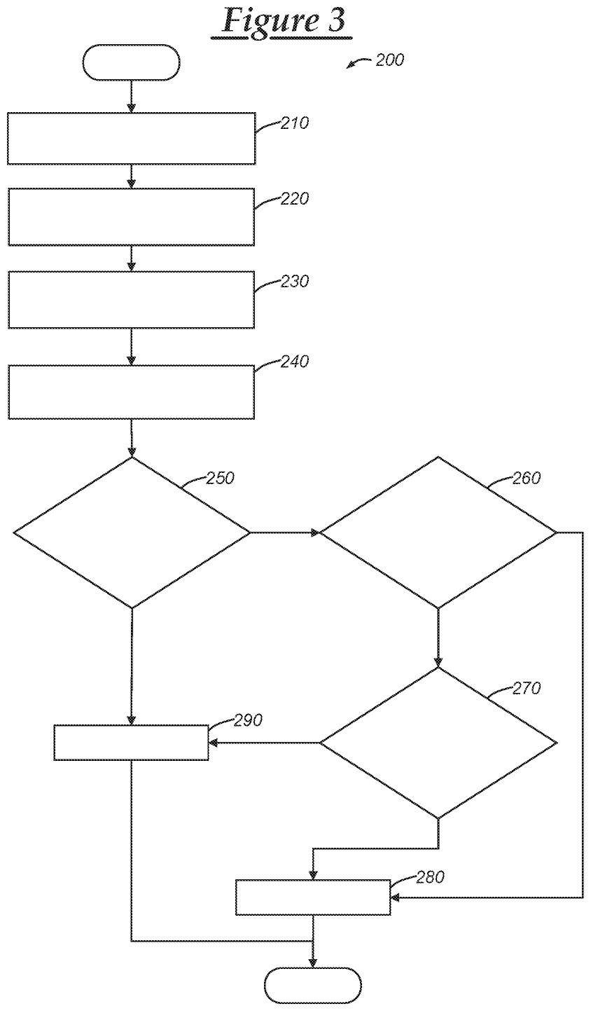

With reference to FIG. 3, there is shown an embodiment of a method 200 of overriding a blacklist indicator for a user equipment (UE). In one embodiment, the method 200 is carried out by the cellular network 70, which may use computer system 74a. Also, the method 200 is carried out for a particular UE, which will generally be described with respect to the telematics unit 42 of the vehicle 12. However, those skilled in the art will appreciate that the method 200 can be applied and/or modified so as to be carried out with other UEs, such as the HWD 90. Also, the method 200 will refer to the technical specification of 3GPP TS 23.401 V8.0.0 (2007-12) in section 5.3.2.1 as an “exemplary 3GPP technical specification”; however, it should be appreciated that the cellular network 70 and/or the method 200 can use a different 3GPP attach procedure or cellular attach procedure. Although the steps of the method 200 are described as being carried out in a particular order, it is hereby contemplated that the steps of the method 200 can be carried out in any suitable order as will be appreciated by those skilled in the art.

The method 200 begins with step 210, wherein a cellular service request is received from a UE. In one embodiment, the telematics unit 42 of the vehicle 12 sends the cellular service request, which is any request for cellular services or a request to be registered or attached to a cellular network or base station for purposes of carrying out cellular services (e.g., cellular communications). For example, the cellular service request can be an attach request, such as the attach request described in step “1. Attach Request” of the exemplary 3GPP technical specification. This attach request (or other cellular service request) can be received at the eNodeB 102 and then sent from the eNodeB 102 to the MME 106. In one embodiment, the cellular service request can include a subscriber identifier (e.g., an IMSI) of the UE, or the subscriber identifier can be sent at a later time and part of a different message. In some embodiments, the subscriber identifier is an IMSI stored in the SIM of the telematics unit 42. For example, the IMSI can be stored in an embedded SIM of the telematics unit 42—thus, in some embodiments, the SIM (or device storing the IMSI) is not separable (or removeable) from the telematics unit 42 (and/or from the IMEI).

In one embodiment, the cellular network can obtain the IMSI (or other subscriber identifier) from an old MME or serving GPRS support node (SGSN) (or other component of the cellular network). For example, as is described in step 3 of the exemplary 3GPP technical specification, an “Identification Request” can be sent to the old MME/SGSN. The old MME/SGSN can then respond with an “Identification Response” that includes the IMSI (or other subscriber identifier) for the UE. In another embodiment, such as where the UE is unknown in both the old MME/SGSN and the MME 106, the MME 106 can send an “Identification Request” to the UE and, in response, the UE can send an “Identification Response” with the IMSI (or other subscriber identifier), such as that which is described in step 4 of the exemplary 3GPP technical specification. The method 200 continues to step 220.

In step 220, subscriber information is retrieved from a subscriber server. In many embodiments, the subscriber server is the HSS/HLR 108. In one embodiment, once the subscriber identifier for the UE is obtained (see step 210), subscriber information is obtained from the subscriber server using the subscriber identifier. In at least one embodiment, the subscriber server is queried by the MME using the subscriber identifier and, in response, the subscriber server returns the subscriber information. In one embodiment, the subscriber information can include an indication that the subscription of the UE (or the subscription associated with the subscriber identifier) is active—this indication is referred to herein as a “subscription indication.” Additionally or alternatively, the subscriber information can include a blacklist override flag. The blacklist override flag indicates whether the cellular services of the UE should be provided regardless of whether the UE (or IMEI) is blacklisted (or in spite of the UE (or IMEI) being blacklisted). In other embodiments, the blacklist override flag and/or the subscription indication can be retrieved from the subscriber server at a later time, such as after step 240 and/or after it is determined that the UE is blacklisted. The method 200 continues to step 230.

In step 230, an equipment identifier is received from the UE. In many embodiments, the equipment identifier is an International Mobile Equipment Identifier (IMEI). And, in some embodiments, the equipment identifier is an IMEI of the telematics unit 42 of the vehicle 12. The IMEI can be stored in memory 38 and/or other memory of the vehicle electronics 20 and can be sent by the telematics unit 42 to the cellular network, such as to the MME. The IMEI can be securely sent and/or may be sent as a part of step “5a. Authentication/Security/ME Identity” of the exemplary 3GPP technical specification. Once the equipment identifier is obtained, the method 200 continues to step 240.

In step 240, it is determined whether the UE (or the IMEI) is blacklisted. As used herein, when the UE is referred to as being “blacklisted,” this can include blacklisting an IMEI or other equipment identifier of the UE. In at least one embodiment, a blacklist indicator can be obtained that indicates whether the UE is blacklisted. In some embodiments, the IMEI that was obtained in step 230 can be sent to the EIR 110, which can then respond by sending an indication of whether the UE is blacklisted. According to at least some embodiments, this indication is typically provided to the cellular device using known 3GPP signaling defined in 3GPP TS 24.008 (3G), 3GPP TS 24.301 (4G), and 3GPP TS 24.501 (5G) and typically takes the form of passing a “cause value” indicating denial of service (e.g., cause value 6—illegal ME (mobile equipment)). In step 250, the MME (or other device of the cellular network) can inspect the blacklist indicator and, when it is determined that the UE (or the IMEI) is blacklisted, then the method 200 continues to step 260; otherwise, the method 200 continues to step 290 where cellular service is enabled and the attach procedure can be carried out until it is successfully completed, for example.

In step 260, it is determined whether the subscriber profile includes a blacklist override flag. As mentioned above with respect to step 220, the subscriber server can be queried using the IMSI to obtain subscriber information, which may include a blacklist override flag. However, in other embodiments, the subscriber information (e.g., subscriber profile) obtained in step 220 may be separate from the blacklist override flag—for example, upon reaching step 260 (or upon determining that the UE (or IMEI) is blacklisted), the subscriber server (e.g., the HSS/HLR 106) can be queried for a blacklist override flag. When no blacklist override flag is obtained from (or exists at) the subscriber server, the method 200 proceeds to step 280. In either of these embodiments, the blacklist override flag can be inspected to determine whether it is set to TRUE or FALSE as depicted in step 270. In other embodiments, the mere presence of a blacklist override flag can indicate that the UE (or IMEI) blacklisting should be overridden. When it is determined that the UE (or IMEI) blacklisting should be overridden, the method 200 continues to step 290 where cellular services are provided; otherwise, the method 200 continues to step 280 where cellular service is denied. In one embodiment, denying cellular service can include ending the attach procedure and/or sending a cellular service denial message to the UE. In one embodiment, the denial of service at step 280 can be carried out in the same manner as if the UE did not have an active subscription. In at least some embodiments, at least some (e.g., all) of the method steps are carried out as a part of a cellular attach procedure or other registration process. And, in one embodiment, the providing step can include carrying out any remaining steps of the attach procedure. The method 200 then ends.

In another embodiment, the subscription identifier (e.g., IMSI) can be associated with a blacklist override equipment list. The blacklist override equipment list can be stored in the subscriber server (e.g., HSS/HLR 106) and can indicate one or more UEs (or equipment identifiers (e.g., IMEIs)) that the blacklist override indicator (or function) should apply to. The blacklist override equipment list can be preconfigured and stored at the HSS/HLR 106 (or other component of the cellular network) when the UE is first configured for use with the cellular network, for example, or at some other suitable time. In one embodiment, when the cellular network retrieves subscription information from the subscriber server, the cellular network can inspect the blacklist override equipment list (which is associated with the subscriber identifier) to determine whether it contains the equipment identifier (e.g., IMEI) received from the UE. When the blacklist override equipment list contains the IMEI of the UE, then the blacklisting of the UE (or the IMEI) can be overridden and the UE provided cellular services (step 290). In one embodiment, the UE is not provided cellular services when it is determined that the subscriber identifier is not associated with an active subscription and/or when it is determined that the subscriber identifier is blacklisted.

In another embodiment, the blacklist override indicator can be stored at a location other than the subscriber server, such as another location of the cellular network. For example, the blacklist override indicator can be stored at the EIR 110. In such a case, the EIR 110 can include two sets of data: the first set can be a blacklist indicator that indicates whether the equipment of the UE has been blacklisted and the second set can be a blacklist override indicator that indicates whether the blacklist indicator should be overridden. Each of these sets of data can be associated with an IMEI (and/or an IMSI). In one embodiment, the first set of data (i.e., the blacklist indicators) can be maintained by an operator of the cellular network and the second set of data (i.e., the blacklist override indicators) can be maintained by an operator of vehicle backend services, such as an original equipment manufacturer (OEM) of the vehicle and/or the telematics unit.

In one embodiment, the method 200 and/or parts thereof can be implemented in one or more computer programs (or “applications”, or “scripts”) embodied in one or more computer readable mediums and including instructions usable (e.g., executable) by one or more processors of the one or more computers of one or more systems. In one embodiment, the method 200 is carried out by the cellular network, such as by the electronic computer 74a, which can include a processor and memory, such as any of those types of processors and/or memory that are discussed above with respect to processor 36 and memory 38 of the wireless communications device 30. The computer program(s) may include one or more software programs comprised of program instructions in source code, object code, executable code, or other formats. In one embodiment, any one or more of the computer program(s) can include one or more firmware programs and/or hardware description language (HDL) files. Furthermore, the computer program(s) can each be associated with any program related data and, in some embodiments, the computer program(s) can be packaged with the program related data. The program related data may include data structures, look-up tables, configuration files, certificates, or other relevant data represented in any other suitable format. The program instructions may include program modules, routines, programs, functions, procedures, methods, objects, components, and/or the like. The computer program(s) can be executed on one or more computers, such as on multiple computers that are in communication with one another.

The computer program(s) can be embodied on computer readable media (e.g., memory at servers 82, memory of computer system 74a, other memory at cellular network 70, a combination thereof), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of overriding a blacklist indicator for a user equipment (UE), the method comprising:
obtaining a subscriber identifier of the UE;
obtaining an equipment identifier from the UE;
retrieving subscriber information from a subscriber server based on the subscriber identifier;
determining whether the equipment identifier is blacklisted;
when it is determined that the equipment identifier is blacklisted,
determining whether the subscriber information includes a blacklist override indicator that indicates to override blacklisting of the equipment identifier; and
when it is determined to override the blacklisting of the equipment identifier, providing cellular services to the UE.

2. The method of claim 1, wherein the subscriber identifier is an international mobile subscriber identity (IMSI).

3. The method of claim 2, wherein the IMSI is stored at the UE in an embedded subscriber identity module (SIM).

4. The method of claim 3, wherein the determining step includes obtaining a blacklist equipment override list based on the IMSI and determining whether the equipment identifier is included in the blacklist equipment override list, wherein the blacklist equipment override list is the blacklist override indicator.

5. The method of claim 1, wherein the subscriber information includes a subscriber profile that is associated with the subscriber identifier.

6. The method of claim 5, wherein the subscriber profile is retrieved from the subscriber server at a time separate than a time in which the blacklist override indicator is retrieved.

7. The method of claim 6, wherein the blacklist override indicator is retrieved in response to determining that the equipment identifier is blacklisted.

8. The method of claim 7, wherein the blacklist override indicator is a blacklist override flag that is stored at the subscriber server.

9. The method of claim 1, wherein the equipment identifier is an international mobile equipment identity (IMEI), and wherein the IMEI is received from the UE via cellular communications.

10. The method of claim 9, wherein the blacklist indicator is received from an equipment identity register (EIR) based on the IMEI.

11. The method of claim 10, wherein the subscriber information, the IMEI, the blacklist indicator, and the blacklist override indicator are received at a mobility management entity (MME).

12. A method of overriding a blacklist indicator for a user equipment (UE), the method comprising:
obtaining an international mobile subscriber identity (IMSI) of a telematics unit of a vehicle, wherein the telematics unit is the UE and wherein the IMSI is stored in an embedded subscriber identity module (SIM) of the vehicle;
receiving an international mobile equipment identity (IMEI) from the telematics unit, wherein the IMEI is stored in memory of the vehicle;
determining whether the IMSI or IMEI is associated with a blacklist override indicator; and
when it is determined that the IMSI or IMEI is associated with a blacklist override indicator, providing cellular services to the telematics unit regardless of whether the IMEI is blacklisted.

13. The method of claim 12, further comprising the step of determining whether the IMEI is blacklisted by querying an equipment identity register (EIR) based on the IMEI.

14. The method of claim 12, wherein the obtaining step and the receiving step are carried out as a part of a 3rd Generation Partnership Project (3GPP) cellular protocol.

15. The method of claim 14, wherein, when it is determined that the IMSI is associated with the blacklist override indicator, providing the cellular services to the telematics unit regardless of whether the IMEI is blacklisted and without making a determination as to whether the IMEI is blacklisted.

16. The method of claim 14, wherein the obtaining step and the receiving step are carried out as a part of an attach procedure and in response to a cellular service request from the UE.

17. The method of claim 16, wherein the method is carried out by a cellular network.

18. The method of claim 17, wherein the method is carried out by a computer system at a cellular base station of the cellular network, wherein the computer system includes one or more electronic computers.

19. The method of claim 12, wherein the method steps are carried out as a part of an attach procedure, and wherein the providing step includes carrying out remaining steps of the attach procedure.

20. The method of claim 12, wherein the blacklist override indicator is stored on the cellular network at a location other than a subscriber server of the cellular network.
